(19) United States
(12) Patent Application Publication
(10) Pub. No.: US 2026/0171015 A1
(43) Pub. Date: Jun. 18, 2026

(54) DISPLAY DEVICE AND ELECTRONIC APPARATUS

(71) Applicants: SONY SEMICONDUCTOR SOLUTIONS CORPORATION, KANAGAWA (JP); SONY GROUP CORPORATION, TOKYO (JP)

(72) Inventors: KAZUKI YOKOYAMA, KANAGAWA (JP); HARUKI TSUCHIYA, TOKYO (JP)

(21) Appl. No.: 19/110,285

(22) PCT Filed: Jul. 20, 2023
(86) PCT No.: PCT/JP2023/026567

§ 371 Date: Mar. 6, 2026

(30) Foreign Application Priority Data
Sep. 16, 2022 (JP) 2022-147567

(51) Int. Cl. G09G 3/3233

(52) U.S. Cl. CPC G09G 3/3233; G09G 2300/0819; G09G 2300/0852; G09G 2300/0861; G09G 2310/0286; G09G 2310/08; G09G 2320/0233; G09G 2320/0247; G09G 2320/041; G09G 2340/0435

(57) ABSTRACT

For example, an object is to improve contrast. Provided is a display device including: a pixel circuit including a light-emitting element, a first transistor that causes a current based on a pixel signal to flow through the light-emitting element, and a second transistor that sets a potential of an anode of the light-emitting element to an initialization potential in an on-state, in which the second transistor is turned on one or more times during a light emission period of the light-emitting element.

### TECHNICAL FIELD

The present technology relates to a display device and an electronic apparatus.

### BACKGROUND ART

A display device using a self-luminous element (light-emitting element) is known. For example, a display device using an organic light emitting diode (OLED) can express black by non-light emission, and is suitable for high contrast.

Patent Document 1 below discloses a display device capable of improving contrast during black display by timing control at the start of light emission of a light-emitting element.

### CITATION LIST

### Patent Document

Patent Document 1: Japanese Patent Application Laid-Open No. 2017-203991

### SUMMARY OF THE INVENTION

### Problems to be Solved by the Invention

By the way, in recent years, the light emission efficiency of the light-emitting element has remarkably evolved, and a new high contrast technology corresponding thereto is desired.

An object of the present technology is to improve contrast. SOLUTIONS TO PROBLEMS

The present technology is, for example, a display device including: a pixel circuit including a light-emitting element, a first transistor that causes a current based on a pixel signal to flow through the light-emitting element, and a second transistor that sets a potential of an anode of the light-emitting element to an initialization potential in an on-state, in which the light emission period second transistor of the light-emitting element is turned on one or more times.

The present technology is, for example, an electronic apparatus including the display device of the present technology.

### BRIEF DESCRIPTION OF DRAWINGS

FIG. 1 is a diagram illustrating a schematic configuration example of a display device to which the present technology can be applied.

FIG. 2 is a diagram illustrating a more detailed configuration example of the display device.

FIG. 3 is a diagram illustrating a configuration example of a pixel circuit of the display device.

FIG. 4 is a diagram for explaining an operation when a pixel outputs a lowest gradation in a comparative example.

FIG. 5 is a diagram illustrating a state of a pixel circuit before start of light emission in the comparative example.

FIG. 6 is a diagram illustrating a state of the pixel circuit in a light emission period in the comparative example.

FIG. 7 is a diagram illustrating an example of a flow of a leakage current immediately after light emission starts in the comparative example.

FIG. 8 is a diagram illustrating an example of a flow of the leakage current after reaching a light emission threshold voltage in the comparative example.

FIG. 9 is a diagram for explaining time-series changes in values related to light emission when a pixel outputs a lowest gradation in the comparative example.

FIG. 10 is a diagram for explaining time-series changes in values related to light emission at the time of white display in the comparative example.

FIG. 11 is a diagram for explaining an operation example when a pixel outputs a lowest gradation in the present embodiment.

FIG. 12 is a diagram for explaining an operation example of a light emission period in the present embodiment.

FIG. 13 is a diagram for explaining time-series changes in values related to light emission at the time of all-black writing in the present embodiment.

FIG. 14 is a diagram for explaining time-series changes in values related to light emission at the time of white display in the present embodiment.

FIG. 15 is a diagram for explaining an operation without a countermeasure for a frame rate change.

FIG. 16 is a diagram for explaining an operation with a countermeasure for a frame rate change.

FIG. 17 is a diagram for explaining a specific example of an operation of a display device.

FIG. 18 is a diagram for explaining a flicker countermeasure.

FIG. 19 is a diagram illustrating a schematic configuration example of another display device to which the present technology can be applied.

FIG. 20 is a diagram illustrating another configuration example of the pixel circuit.

FIG. 21 is a diagram illustrating another configuration example of the pixel circuit.

FIG. 22 is a diagram illustrating another configuration example of the pixel circuit.

FIG. 23 is a diagram illustrating another configuration example of the pixel circuit.

FIG. 24 is a diagram illustrating another configuration example of the pixel circuit.

FIG. 25 is a diagram illustrating another configuration example of the pixel circuit.

FIG. 26 is a diagram for explaining an influence on driving of another pixel circuit.

FIG. 27 is a diagram for explaining another specific example of the operation of the display device.

FIG. 28 is a perspective view illustrating an example of an external appearance of a head mounted display.

FIG. 29 is a perspective view illustrating an example of an appearance of a see-through head mounted display.

FIG. 30A is a front view illustrating an example of an external appearance of a digital still camera. FIG. 30B is a rear view illustrating the example of the external appearance of the digital still camera.

FIG. 31 is a perspective view illustrating an example of an external appearance of a television device.

FIG. 32 is a perspective view illustrating an example of an external appearance of a smartphone.

FIG. 33A is a diagram illustrating an example of an internal state of a vehicle from a rear side to a front side of the vehicle. FIG. 33B is a diagram illustrating an example of an internal state of the vehicle as viewed from the oblique rear to the oblique front of the vehicle.

### MODE FOR CARRYING OUT THE INVENTION

Embodiments and the like of the present technology are described below, with reference to the drawings. The description will be given in the following order.
<1. First embodiment>
1-1. Configuration example of display device
1-2. Configuration example of pixel circuit
1-3. Operation example of display device in comparative example
1-4. Operation example of display device according to present embodiment
<2. Second embodiment>
<3. Another configuration example of pixel circuit>
<4. Application example>
<5. Modification>

### 1. First Embodiment

### 1-1. Configuration Example of Display Device

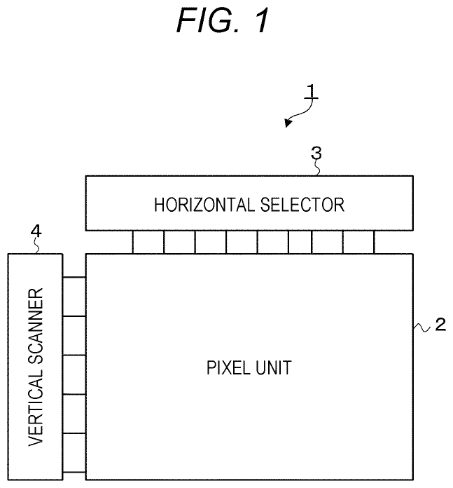

FIG. 1 illustrates a schematic configuration example of a display device 1 (electro-optical device) to which the present technology can be applied. The display device 1 is an organic electro luminescence (EL) display device including an active matrix type drive circuit and using an OLED as a light-emitting element. The organic EL display device is characterized by high visibility, low power consumption, and weight reduction and thickness reduction as compared with conventional liquid crystal display devices and the like. In addition, it is characterized in that, since the response speed is high, an afterimage feeling does not occur, and further, since a backlight is unnecessary, black can be expressed by non-light emission, which is suitable for high contrast. Note that the display device 1 may use another light-emitting element such as a micro LED (Light Emitting Diode) or a quantum dot light-emitting element.

As illustrated in FIG. 1, the display device 1 includes a pixel portion 2, a horizontal selector 3, and a vertical scanner 4. These are formed on a semiconductor substrate such as a silicon substrate. With respect to the pixel portion 2, a plurality of signal lines extends in the vertical direction from the horizontal selector 3, and a plurality of scanning lines extends in the horizontal direction from the vertical scanner 4.

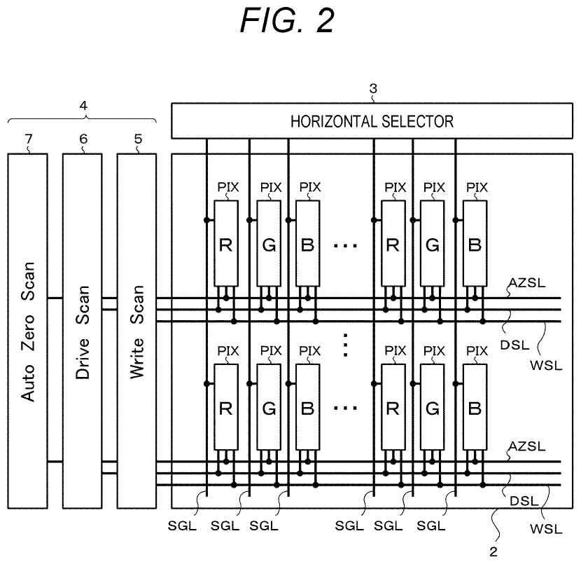

FIG. 2 illustrates a more detailed configuration example of the display device 1. As illustrated in FIG. 2, in the pixel portion 2, a signal line SGL is wired for each pixel column along the column direction (the arrangement direction of the pixels of the pixel column) with respect to the arrangement of the pixels PIX (pixel circuits) in the matrix shape. In addition, a control line group (control lines WSL, DSL, and AZSL) is wired for each pixel row along the row direction (the arrangement direction of the pixels of the pixel row) with respect to the arrangement of the pixels PIX in the matrix shape. Each signal line SGL is connected to each pixel PIX in the corresponding pixel column, and each of the control lines WSL, DSL, and AZSL is connected to each pixel PIX in the corresponding pixel row.

In the pixel portion 2, as indicated by red (R), green (G), and blue (B), pixels PIX corresponding to pixels of three primary colors are provided. These three pixels represent one dot of a color image. Note that the combination of pixels expressing one dot is not limited to this, and a W (white) pixel for improving luminance may be added, or a complementary pixel for expanding a color reproduction range may be added. Further, the pixel PIX is not limited to the color image, and may be configured to express a monochrome (black-and-white) image.

The vertical scanner 4 includes a write scanner 5, a drive scanner 6, and an auto zero scanner 7. Each of these scanners includes a shift register circuit or the like.

Each signal line SGL is connected to an output end of a corresponding column of the horizontal selector 3. In addition, each control line (scanning line) WSL is connected to an output end of a corresponding row of the write scanner 5. Each control line DSL is connected to an output end of a corresponding row of the drive scanner 6. Each control line AZSL is connected to an output end of a corresponding row of the auto zero scanner 7. Note that a plurality of types of signal lines SGL and control lines WSL, DSL, and AZSL may be provided according to the type of pixel PIX.

The horizontal selector 3 supplies a pixel signal based on a video signal supplied from a control circuit (not illustrated) or the like to each signal line SGL. For example, the horizontal selector 3 selectively outputs, as pixel signals, a signal voltage Vsig, a first reference voltage Vref, and a second reference voltage Vofs corresponding to video signals. The first reference voltage Vref is a reference voltage for reliably turning off the pixel PIX. The second reference voltage Vofs is a voltage (for example, a voltage corresponding to the black level of the video signal) serving as a reference of the signal voltage Vsig corresponding to the video signal, and is used when a threshold value correction operation for correcting a threshold value voltage of a drive transistor described later is performed.

The write scanner 5 controls writing of a pixel signal to each pixel PIX. For example, when writing a pixel signal to each pixel PIX of the pixel portion 2, the write scanner 5 sequentially supplies a control signal to each control line WSL to sequentially scan (line sequential scan) each pixel PIX of the pixel portion 2 row by row. The drive scanner 6 controls light emission/extinction (non-light emission) of each pixel PIX. Specifically, the drive scanner 6 controls light emission/extinction of the pixel PIX by supplying a control signal to the control line DSL in synchronization with scanning of the write scanner 5. The auto zero scanner 7 controls initialization of each pixel PIX. Specifically, the auto zero scanner 7 supplies a control signal to the control line AZSL in synchronization with the scanning of the write scanner 5 to perform control such that the pixel PIX does not emit light during the extinction period.

### 1-2. Configuration Example of Pixel Circuit

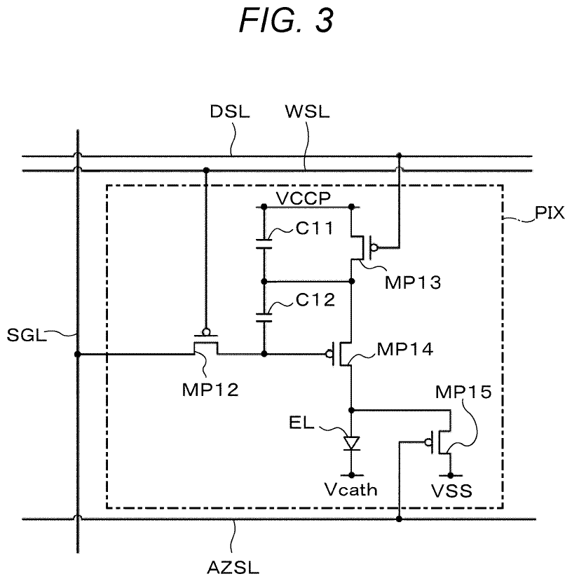

FIG. 3 illustrates a configuration example of the pixel PIX. The pixel PIX illustrated in FIG. 3 includes capacitors C11 and C12, transistors MP12 to MP15, and a light-emitting element EL. The transistors MP12 to MP15 are P-type MOSFETs. The gate of the transistor MP12 is connected to the control line WSL, the source is connected to the signal line SGL, and the drain is connected to the gate of the transistor MP14 and the capacitor C12. One end of the capacitor C11 is connected to a power supply line VCCP, and the other end is connected to the capacitor C12, the drain of the transistor MP13, and the source of the transistor MP14. One end of the capacitor C12 is connected to the other end of the capacitor C11, the drain of the transistor MP13, and the source of the transistor MP14, and the other end is connected to the drain of the transistor MP12 and the gate of the transistor MP14. The gate of the transistor MP13 is connected to the control line DSL, the source is connected to the power supply line VCCP, and the drain is connected to the source of the transistor MP14, the other end of the capacitor C11, and one end of the capacitor C12. The gate of the transistor MP14 is connected to the drain of the transistor MP12 and the other end of the capacitor C12, the source is connected to the drain of the transistor MP13, the other end of the capacitor C11, and one end of the capacitor C12, and the drain is connected to the anode of the light-emitting element EL and the source of the transistor MP15. The gate of the transistor MP15 is connected to the control line AZSL, the source is connected to the drain of the transistor MP14 and the anode of the light-emitting element EL, and the drain is connected to the power supply line VSS. The anode of the light-emitting element EL is connected to the drain of the transistor MP14 and the source of the transistor MP15, and the cathode is connected to a power supply line Vcath.

With this configuration, in the pixel PIX, the transistor MP12 is in an on state, so that the voltage between both ends of the capacitor C12 is set on the basis of the pixel signal supplied from the signal line SGL. The transistor MP13 is turned on and off on the basis of the signal of the control line DSL. The transistor MP14 causes a current corresponding to the voltage between both ends of the capacitor C12 to flow through the light-emitting element EL during the period in which the transistor MP13 is in an on state. The light-emitting element EL emits light on the basis of the current supplied from the transistor MP14. In this manner, the pixel PIX emits light with luminance corresponding to the pixel signal. The transistor MP15 is turned on and off on the basis of the signal of the control line AZSL. During the period in which the transistor MP15 is in an on state, the voltage of the anode of the light-emitting element EL is initialized by being set to the voltage of the power supply line VSS, that is, the initialization potential. Hereinafter, the transistor MP14 will be appropriately referred to as a driving transistor (first transistor), the transistor MP15 as an initialization transistor (second transistor), and the transistor MP13 as a light emission control transistor (third transistor).

### 1-3. Operation Example of Display Device in Comparative Example

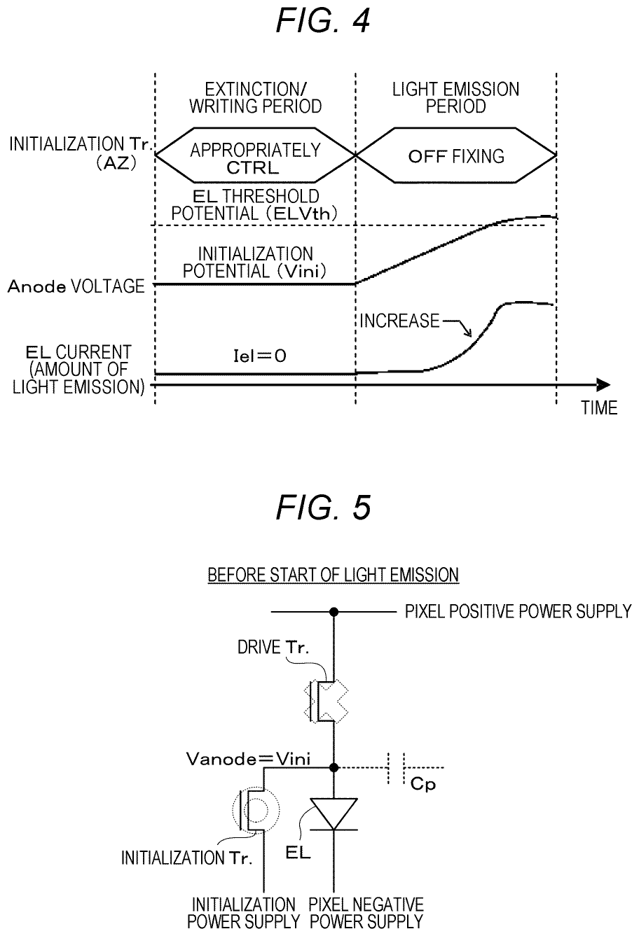

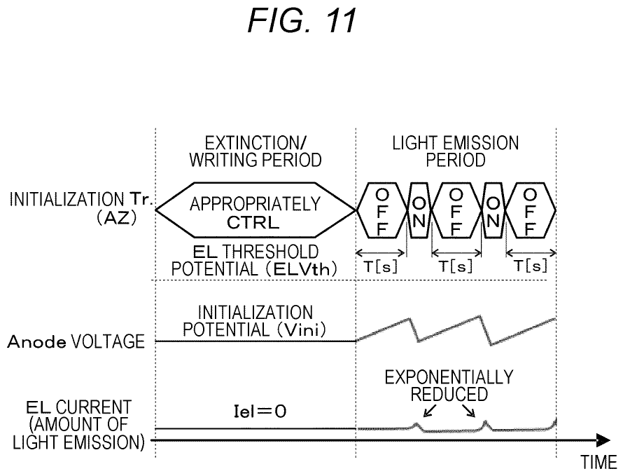

Before describing an operation example of the display device 1 according to the present embodiment, first, an operation in a comparative example will be described. FIG. 4 is a diagram for explaining an operation at the time of full black (perfect black) display in the comparative example. Note that FIG. 4 illustrates time-series changes in the operation of the initialization (AZ) transistor, the anode (hereinafter, simply abbreviated as anode) voltage of the light-emitting element EL, and the EL current (amount of light emission) flowing through the light-emitting element EL. The similarity applies to FIGS. 11, 15, and 16 described later.

As illustrated in the drawing, in the extinction/writing period, the initialization transistor is appropriately controlled, that is, turned on, the potential of the anode maintains the initialization potential (Vini), and the light-emitting element EL does not emit light (EL current Iel=0). On the other hand, in the light emission period, it is naturally necessary to cause a current to flow through the light-emitting element EL, and thus the initialization transistor is usually driven in a closed state. Therefore, the initialization transistor is basically fixed to off during the light emission period. In this case, even if the driving transistor is turned off and completely closed when the pixel outputs the lowest gradation, a leakage current is generated and a current is supplied to the anode, and the potential of the anode increases. For example, in a case where the leakage current is constant, the leakage current increases linearly. As a result, for example, in a case where the light emission efficiency of the light-emitting element EL is high, the potential of the anode exceeds the light emission threshold potential (ELVth) of the light-emitting element EL, and finally, a phenomenon in which a current starts to flow through the light-emitting element EL and the contrast is deteriorated may occur. Hereinafter, a detailed description will be given with reference to the drawings.

FIG. 5 illustrates a state of a peripheral circuit of the light-emitting element EL before start of light emission in the comparative example. Before the start of light emission, the initialization transistor is appropriately turned on to set the anode voltage to the initialization voltage with an image of conducting with the initialization power supply. Specifically, the drive transistor is turned off (in the drawing, represented by a broken line cross mark), and the initialization transistor is turned on (in the drawing, represented by a dashed circle mark). As a result, the potential of the anode (Vanode) becomes the initialization potential (Vanode=Vini), and the potential of the anode is initialized. In a general state, since the initialization voltage (potential) is not a voltage at which the light-emitting element EL emits light, the light-emitting element EL is in a state of not emitting light. With this state as a start, light emission is started. Note that the capacitance Cp in the drawing represents a parasitic capacitance parasitic on the anode. The parasitic capacitance is a capacitance generated between the anode and various circuits.

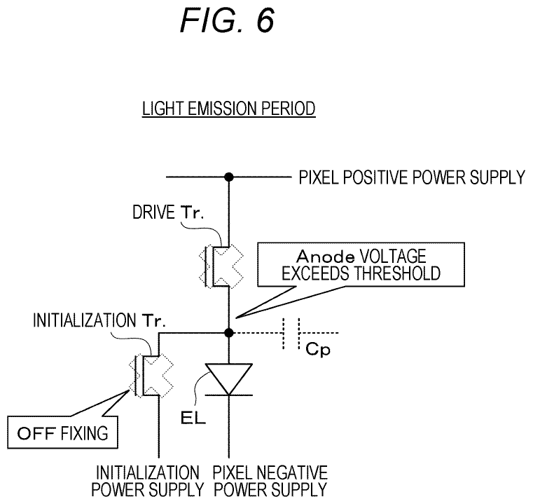

FIG. 6 illustrates a state of a peripheral circuit of the light-emitting element EL in the light emission period in the comparative example. In the light emission period, the potential of the anode is not initialized by the initialization transistor. Specifically, as illustrated in the drawing, the drive transistor is turned off, and the initialization transistor is also fixed to off. Therefore, as described above, the potential of the anode exceeds the light emission threshold potential, and the potential rise of the anode generates the EL current (I_EL) flowing through the light-emitting element EL and exponentially increases as illustrated in FIG. 4. This will be described in more detail below.

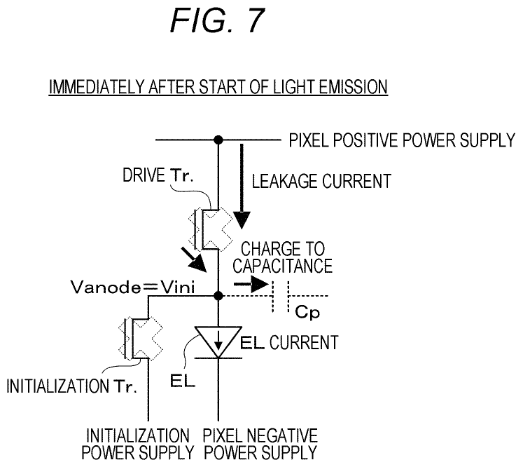

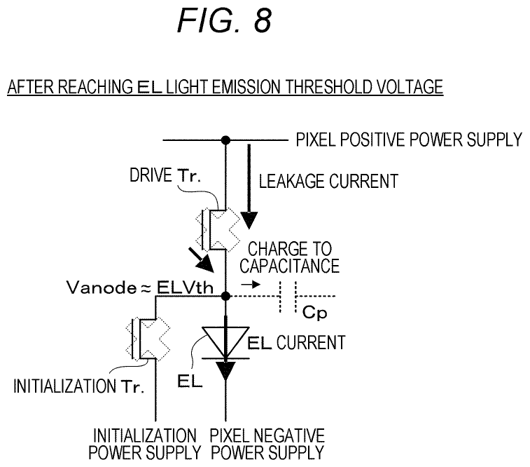

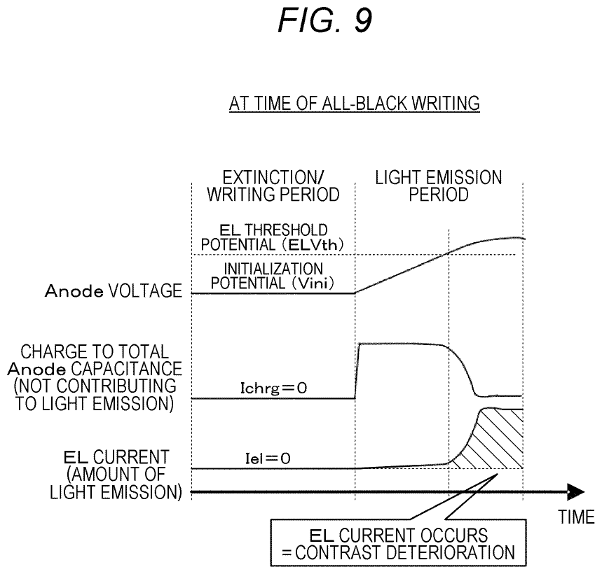

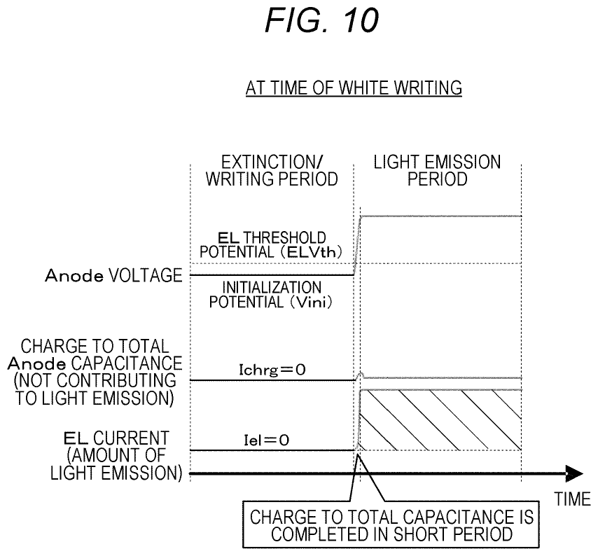

FIG. 7 illustrates an example of a flow of a leakage current immediately after the start of light emission in the comparative example, and FIG. 8 illustrates an example of a flow of a leakage current after reaching the light emission threshold voltage in the comparative example. Furthermore, FIG. 9 is a diagram for explaining the time-series changes in values related to light emission when the pixel in the comparative example outputs the lowest gradation (at the time of all-black writing). FIG. 9 illustrates time-series changes in the anode voltage, the charge current to the total anode capacitance not contributing to light emission, and the EL current (amount of light emission) flowing through the light-emitting element EL. The similarity applies to FIGS. 10, 13, and 14 described later.

In FIGS. 7 and 8, the anode leakage current (I_leak) is a value (I_leak=I_CHRG+I_EL) obtained by adding the charge current (I_CHRG) to the parasitic capacitance Cp and the EL current (I_EL) flowing through the light-emitting element EL. As illustrated in FIG. 7, immediately after the start of light emission, the initialization transistor is in a closed state (off) at the start of light emission. When the pixel outputs the lowest gradation, the drive transistor is also basically turned off, but the anode voltage gradually increases due to various leakage currents such as leakage between the drain and the source of the drive transistor, leakage between the gate and the drain, and leakage between wiring lines from another node. Since the charge associated therewith is charged in the parasitic capacitance Cp of the anode, the current flowing through the light-emitting element EL is very small as illustrated in FIG. 9. That is, the potential of the anode remains at the initialization potential (Vanode=Vini), the leakage current and the charge current to the parasitic capacitance Cp are in an approximate state (I_leak≈I_CHRG), and the EL current flowing through the light-emitting element EL with respect to the leakage current is very small (I_EL<<I_leak). Therefore, the contrast is not affected.

Thereafter, as illustrated in FIG. 9, the charge to the entire anode capacitance progresses, and after the potential of the anode rises to about the light emission threshold potential, the current used for the charge to the parasitic capacitance Cp becomes slight, and a situation in which the leaked amount flows into the light-emitting element EL almost as it is occurs. That is, as illustrated in FIG. 8, when the potential of the anode reaches near the light emission threshold potential (Vanode≈ELVth), the charge current to the parasitic capacitance Cp becomes substantially zero (I_CHRG≈0), and the EL current flowing through the light-emitting element EL becomes substantially equal to the leakage current (I_EL≈I_leak). Since the recent light-emitting element EL has high efficiency, a state in which black floats due to slight light emission even with such a slight leakage current may occur. The EL current flowing through the light-emitting element EL increases exponentially due to the increase in the anode potential, and in particular, the visibility of the contrast rapidly deteriorates near the light emission threshold potential.

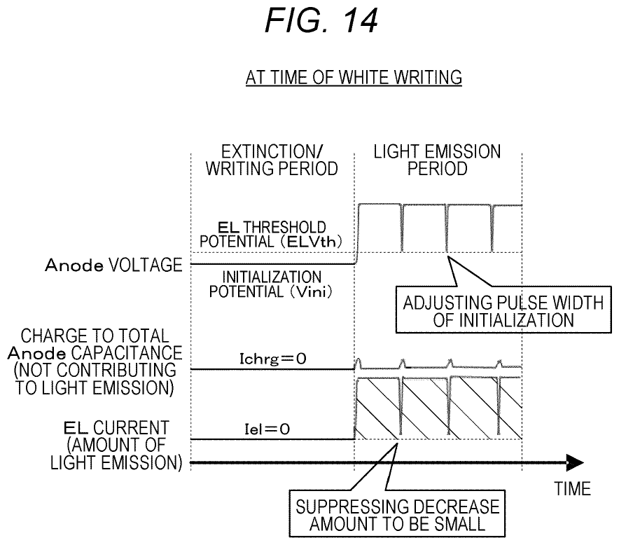

Here, white display according to a comparative example will also be described. FIG. 10 is a diagram for explaining time-series changes in values related to light emission at the time of white display (at the time of white writing) in the comparative example. Note that, in FIG. 10, the scale on the vertical axis is greatly different from that illustrated in FIG. 9 according to the contrast ratio. The similarity applies to FIG. 14 described later.

At the time of white display, the drive transistor is turned on and the initialization transistor is fixed to off during the light emission period. At the time of white display, the amount of current flowing into the anode during the light emission period is much larger than that when the pixel outputs the lowest gradation. Therefore, as illustrated in the drawing, charging of the entire anode capacitance is completed in a very short period. Thereafter, the state transitions to a stable state at a constant current, and light emission is continued while the stable state is maintained. Therefore, there is no particular problem at the time of white display. The similarity applies to other colors except for full black.

### 1-4. Operation Example of Display Device According to Present Embodiment

### 1-4-1. General Operation Example of Display Device

Next, an operation example of the display device 1 according to the present embodiment will be described. As described in the comparative example described above, when the initialization transistor is fixed to off during the light emission period, the potential of the anode increases due to the leakage current. Then, when the light emission threshold potential of the light-emitting element EL is reached, the ratio of the EL current flowing through the light-emitting element EL rapidly increases, the ratio of the charge current to the parasitic capacitance Cp decreases, and the current exponentially flows through the light-emitting element EL (see FIG. 9). However, in a case where the light emission period is short, the light emission period ends while the light-emitting element EL does not emit light, and the initialization operation starts again, so that it is possible to maintain almost no light emission. Therefore, in the present embodiment, in order to prevent the phenomenon of the contrast deterioration in the comparative example described above, the operation is performed such that the substantial light emission period is shortened.

FIG. 11 is a diagram for explaining an operation example when the pixel outputs the lowest gradation in the present embodiment. In the present embodiment, the initialization transistor is turned on once or more during the light emission period, thereby preventing the potential of the anode from exceeding the light emission threshold potential of the light-emitting element EL and improving the contrast. That is, as described above, the initialization transistor is originally fixed to off during the light emission period, but in the present embodiment, a period in which the initialization transistor is turned on is provided during the light emission period. As a result, the potential of the anode drops while being turned on and returns to the initialization potential, and the EL current flowing through the light-emitting element EL can be exponentially reduced.

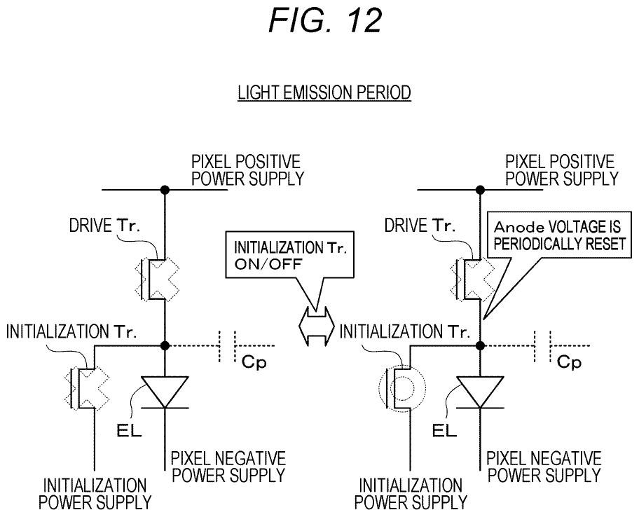

Specifically, as illustrated in the drawing, the initialization transistor is turned on at an appropriate frequency during the light emission period. As a result, the potential of the anode is reset at an appropriate frequency. By resetting the anode potential, the EL current flowing through the light-emitting element EL is exponentially reduced, and the contrast is improved. That is, as illustrated in FIG. 12, the anode potential is periodically initialized by appropriately turning on and off the initialization transistor during the light emission period.

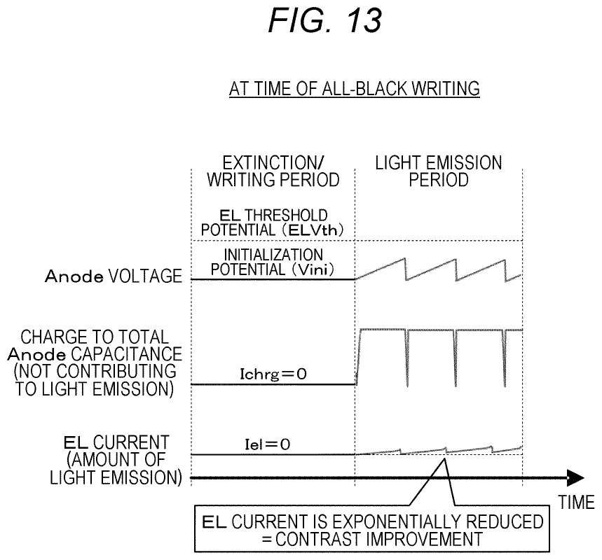

FIG. 13 is a diagram for explaining the time-series changes in values related to light emission when the pixel outputs the lowest gradation in the present embodiment (at the time of all-black writing). By turning on and opening the initialization transistor during the light emission period, the potential of the anode is appropriately dropped to the initialization potential. Then, the potential of the anode is prevented from exceeding the light emission threshold potential of the light-emitting element EL. Specifically, the potential of the anode is initialized before the potential of the anode approaches the light emission threshold potential. As a result, the anode potential at the time of black display is always kept low, and the EL current flowing through the light-emitting element EL can be kept in a very small state. Since the IV characteristic (current-voltage characteristic) of the light-emitting element EL is exponential, as a result, the contrast can be improved exponentially.

For example, during the light emission period, the initialization transistor operates at an on-off rate different from that in a period other than the light emission period (appropriately controlled extinction period/writing period). As a result, versatility and diversity of the operation of the pixel PIX can be enhanced. Specifically, the period during which the initialization transistor is turned on in the light emission period is a sufficiently short period (for example, 10 to 1/100) with respect to 1H (horizontal period), and the number of times of turning on may be one or more. The on period is preferably shorter than the period other than the light emission period, for example. The light emission efficiency can be enhanced by setting the period to be short. This on period is determined, for example, according to the capability of the initialization transistor, that is, device characteristics. If the anode potential can be lowered to a desired value, the shortest time according to the device characteristics may be set. Note that the number of times of on is determined by, for example, the relationship between the set on period and the amount of leakage current of the anode. With this determination, the number of times of on can be appropriately set. These periods and the number of times can be appropriately set.

For example, in order to keep the contrast high, it is desirable that Formula (1) below is satisfied with respect to a period T [s] (see FIG. 11) from the end of initialization of the anode potential to the start of the next initialization. Note that ILeak [A] in Formula (1) represents the sum of leakage currents flowing into the anode when the pixel outputs the lowest gradation, CAnode [F] represents the total parasitic capacitance of the anode (including the capacitance of the light-emitting element EL), and VthEL [V] represents the EL voltage corresponding to the EL current at which deterioration in contrast visibility is recognized. As a result, the contrast when the pixel outputs the lowest gradation can be accurately and appropriately improved.

$$\begin{matrix}[ Math . 1 ] & \\ \frac{T [ s ] \times {I}_{leak} [ A ]}{{C}_{Anode} [ F ]} < {Vth}_{EL} [ V ] & ( 1 )\end{matrix}$$

Here, white display according to the present embodiment will be described. FIG. 14 is a diagram for explaining time-series changes in values related to light emission at the time of white display (at the time of white writing) in the present embodiment. In the present embodiment, since the initialization transistor is opened during the light emission period, the potential of the anode drops to the initialization potential for a moment as appropriate. Accordingly, the current charged to the entire anode capacitance of the anode decreases. Since the current flowing through the light-emitting element EL also decreases only during the open period, there is a concern that a partial loss occurs in the light emission current and the substantial light emission efficiency slightly decreases. However, the initialization pulse that initializes the potential of the anode (the on period of the initialization transistor) can reset the anode potential even with a very short width. In particular, when the pixel outputs the lowest gradation, the amount of leakage current, that is, the charge supply to the anode is very small, and a sufficient current decrease can be expected only by opening the initialization transistor for a moment. Therefore, by opening the initialization transistor with a pulse of a very short period as compared with the light emission period, a substantial decrease in the light emission efficiency can be suppressed to be small. Therefore, for example, the period during which the initialization transistor is turned on in the light emission period is set to a period during which the decrease in the light emission current during light emission of the light-emitting element EL falls within a predetermined amount. As described above, by adjusting the pulse width of initialization, in other words, by adjusting the period during which the initialization transistor is on, it is possible to suppress a decrease in the current flowing through the light-emitting element EL at the time of white display. For this reason, it is desirable that the on period of the initialization transistor is as short as possible within a range in which initialization can be performed, and the number of times of initialization is small. The on period and the number of times of on are only required to be appropriately determined in consideration of the balance with the contrast.

### 1-4-2. Specific Example of Operation of Display Device

### Specific Example 1

In a case where the display device 1 supports a plurality of different frame rates (FR), it is preferable that the initialization of the anode potential by the initialization transistor in the light emission period described above operates without changing the physical period of the initialization and the period between the initialization even when the operation frame rate changes. Specifically, the on/off period of the initialization transistor during the light emission period at the low frame rate is made the same as the time length of the on/off period of the initialization transistor during the light emission period at the high frame rate.

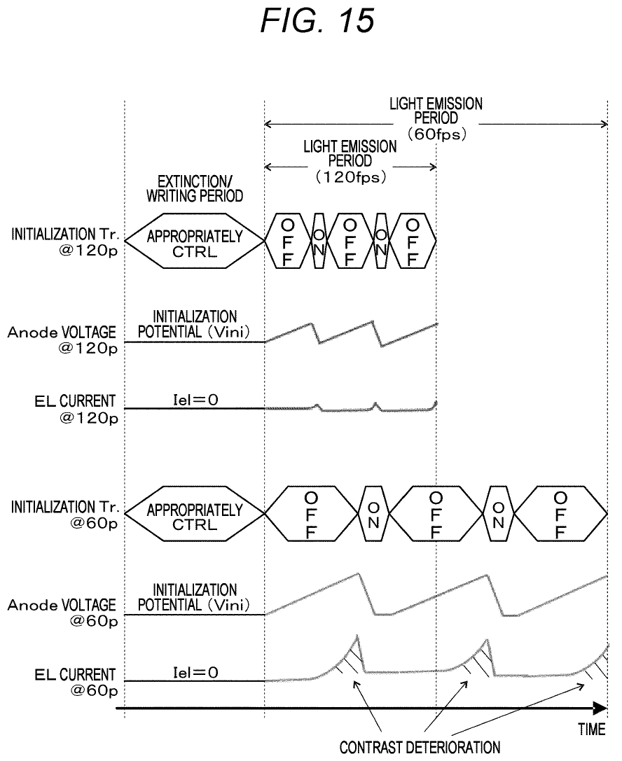

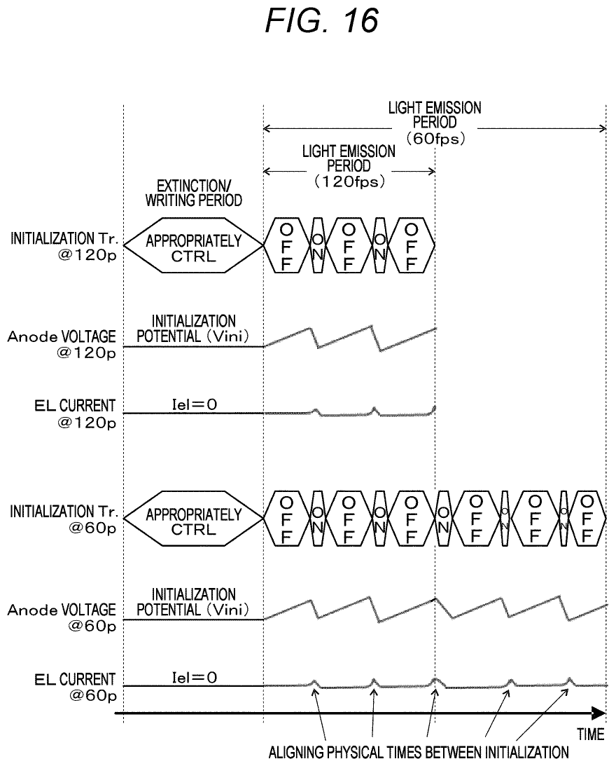

FIG. 15 is a diagram for explaining an operation without a countermeasure for a frame rate change. In FIG. 15 (the similarity applies to FIG. 16), the operation at 120p (progressive scanning) is illustrated in the upper stage, and the operation at 60p is illustrated in the lower stage. In the case of driving at different frame rates, there is a problem that the light emission amount of the light-emitting element EL differs between low frames per second (fps) and high fps. In a case where no countermeasure against the frame rate change is taken, for example, as illustrated in the drawing, even if the potential of the anode can be appropriately initialized so that the contrast does not deteriorate at 120p, the potential of the anode cannot be appropriately initialized by the operation as it is at 60p. That is, if the light emission duty ratio is common between both, a physical period between initialization at 60p extends, and the contrast deteriorates. In order to prevent the contrast from deteriorating at a low frame rate, it is preferable to take measures against a change in the frame rate as follows.

FIG. 16 is a diagram for explaining an operation with a countermeasure for a change in a frame rate. In order to solve the problem due to the difference in frame rate described above, physical periods between initialization are equalized at each frame rate, and the light emission amount of the light-emitting element EL is made to coincide between low fps and high fps. This makes it possible to maintain contrast even at a low frame rate. That is, it is important to align physical periods between initialization. For example, the period during which the initialization transistor is turned on and off is set to the common absolute time in accordance with the high frame rate. By performing the initialization operation so as to maintain the physical period with respect to the change in the frame rate in this manner, it is possible to take a direct measure against the phenomenon in which the contrast deteriorates at a low frame rate. That is, in a case where a plurality of frame rates is supported, the initialization operation can be appropriately performed at each frame rate. Note that the display device 1 may support three or more frame rates. In that case, for example, the on/off time of the highest frame rate is only required to be set as the on/off period of another frame rate.

### Specific Example 2

As described above, the display device 1 according to the present embodiment turns on the initialization transistor during the light emission period of the light-emitting element EL, but the light emission period here is not limited to the case where the light emission control transistor is turned on to cause the light-emitting element EL to emit light, and the off period of the light emission control transistor may be included in at least a part of the period in which the initialization transistor is turned on.

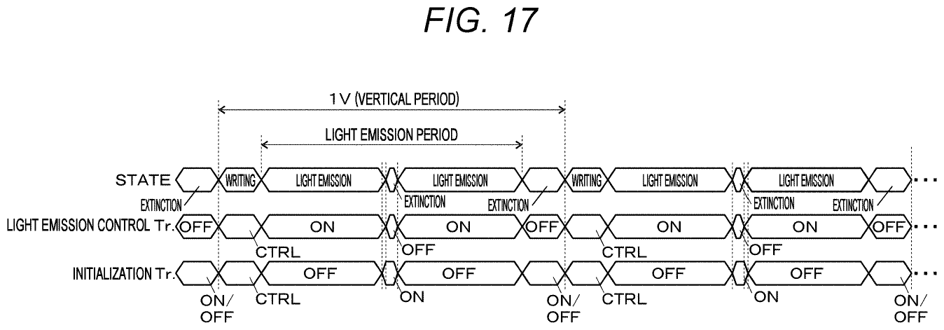

FIG. 17 is a diagram for explaining a specific example of the operation of the display device 1. The light emission period varies depending on the type of pixel circuit to be used. For example, in the case of the 4Tr2c pixel circuit illustrated in FIG. 3, on/off of the light emission control transistor directly controls light emission/extinction. Therefore, the light emission control transistor is basically turned on in the light emission period, but as illustrated in the drawing, the off period of the light emission control transistor may be included in at least a part of the period in which the initialization transistor is turned on. Consequently, the operation of the display device 1 can be diversified. Even in this case, the contrast can be improved as described above. As described above, the light emission period in which the initialization transistor is turned on includes a period in which the light emission control transistor is turned off. The operation of turning off the light emission control transistor is different from, for example, an operation in a normal extinction/writing period.

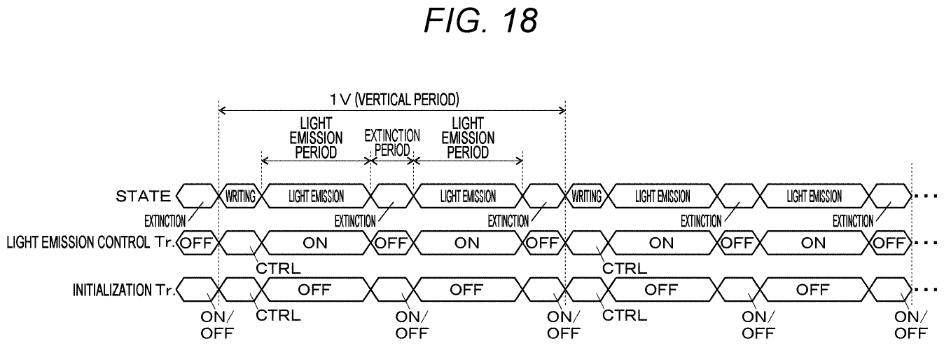

FIG. 18 is a diagram for explaining a flicker countermeasure. When light emission in a long light emission period and extinction in a long extinction period are repeated, flicker such as flickering and blinking may occur. Therefore, as illustrated in the drawing, it is possible to suppress flicker by dividing the light emission period so that light emission/extinction is performed a plurality of times for one write. That is, the light emission control transistor is intentionally turned off to be extinguished during the light emission period, thereby implementing a flicker countermeasure. Note that the extinction for dividing the light emission period is performed by the same operation as in the other extinction periods, and the lengths of the extinction periods are also the same. The extinction accompanying the initialization in Specific example 2 described above is performed by an operation different from that in the other extinction periods, and is shorter than the length of the other extinction periods as illustrated in FIG. 17.

### Specific Example 3

In addition, it is preferable that the anode potential is initialized by the initialization transistor in the light emission period described above at a limited timing within one horizontal period. That is, in the above-described period in which the initialization transistor is turned on, the initialization is further performed at a specific timing within one horizontal period. This timing is a timing that does not affect other operations (for example, write, light emission, and extinction operations of all pixels PIX including the pixel

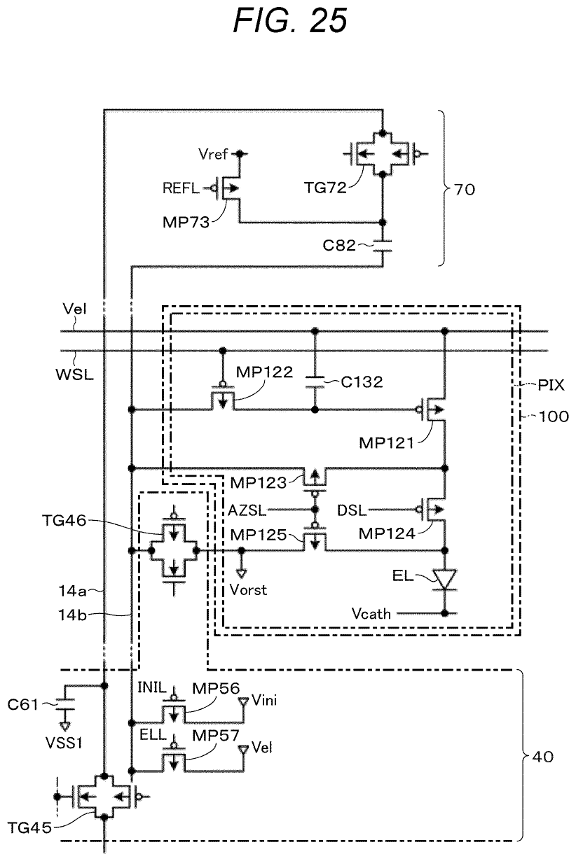

PIX). By performing initialization at a timing that does not affect other operations, the initialization operation can be appropriately performed without affecting other operations. Note that an example of Specific example 3 will be described later by taking the pixel circuit illustrated in FIG. 25 as an example.

### 2. Second Embodiment

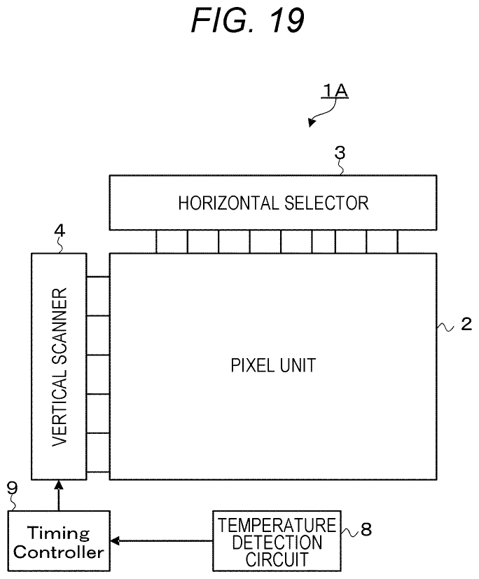

FIG. 19 illustrates a schematic configuration example of a display device 1A (electro-optical device) to which the present technology can be applied. In addition to the operation of the display device 1 described above, the display device 1A performs an operation of selecting the optimum on/off rate following the change in the leakage current (I_leak) described above in conjunction with the temperature sensor when outputting a control signal for controlling on/off of the initialization transistor.

As illustrated in FIG. 19, the display device 1A includes a pixel portion 2, a horizontal selector 3, a vertical scanner 4, a temperature detection circuit 8, and a timing controller 9. The pixel portion 2, the horizontal selector 3, and the vertical scanner 4 have functional configurations similar to those of the display device 1 of the first embodiment described above, and only differences will be described here.

The temperature detection circuit 8 includes a temperature sensor. For example, as the temperature sensor, a known temperature sensor such as a semiconductor temperature sensor, a resistance temperature detection element whose resistance value changes according to temperature, or a thermistor can be used. The temperature sensor is installed, for example, at an appropriate position on the panel on which the pixel portion 2 is formed. Note that the number of temperature sensors may be two or more. The temperature detection circuit 8 outputs information indicating the panel environmental temperature detected by the temperature sensor as the temperature of the pixel PIX to the timing controller 9.

The timing controller 9 is a circuit that controls the operation of the vertical scanner 4, and generates information for feeding back information indicating the panel environmental temperature input from the temperature detection circuit 8 to a generation rate of a control signal (see FIG. 2) output from the auto zero scanner 7 of the vertical scanner 4 to each control line AZSL. The vertical scanner 4 feeds back each control signal according to information input from the timing controller 9, and outputs the fed back control signal to each control line AZSL.

For example, in a high-temperature environment, the leakage current of the drive transistor tends to increase. In addition, the light emission threshold voltage of the light-emitting element EL tends to be reduced. For these reasons, the contrast is likely to deteriorate in a device using the light-emitting element EL in a high-temperature environment. Therefore, the higher the temperature at which the contrast is likely to deteriorate, the higher the initialization rate (increase the on rate of the initialization transistor).

The pixel portion 2 detects an initialization rate of the pixel PIX and performs an appropriate initialization operation according to the panel environmental temperature. As described above, by optimizing the on/off period of the initialization transistor according to the temperature of the pixel PIX, it is possible to eliminate a phenomenon in which the contrast deteriorates in a high-temperature environment. Note that the temperature detection circuit 8 and the timing controller 9 may be incorporated in the vertical scanner 4 or the like.

### 3. Another Configuration Example of Pixel Circuit

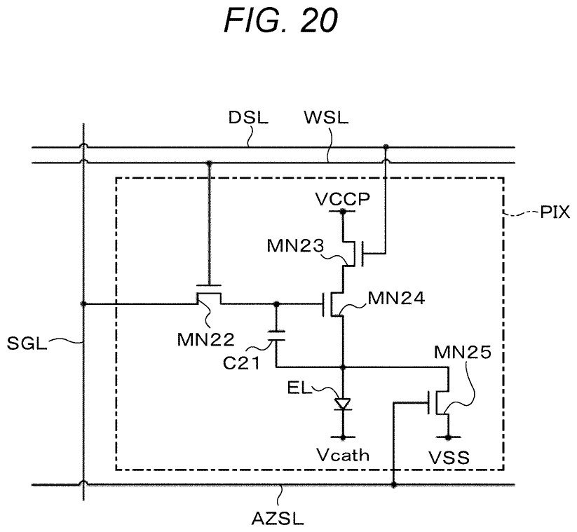

The pixel PIX to which the present technology can be applied is not limited to the configuration illustrated in FIG. 3. FIG. 20 illustrates another configuration example of the pixel PIX. The pixel PIX includes a capacitor C21, transistors MN22 to MN25, and a light-emitting element EL. The transistors MN22 to MN25 are N-type MOSFETs. The gate of the transistor MN22 is connected to the control line WSL, the drain is connected to the signal line SGL, and the source is connected to the gate of the transistor MN24 and the capacitor C21. One end of the capacitor C21 is connected to the source of the transistor MN22 and the gate of the transistor MN24, and the other end is connected to the source of the transistor MN24, the drain of the transistor MN25, and the anode of the light-emitting element EL. The gate of the transistor MN23 is connected to the control line DSL, the drain is connected to the power supply line VCCP, and the source is connected to the drain of the transistor MN24. The gate of the transistor MN24 is connected to the source of the transistor MN22 and one end of the capacitor C21, the drain is connected to the source of the transistor MN23, and the source is connected to the other end of the capacitor C21, the drain of the transistor MN25, and the anode of the light-emitting element

EL. The gate of the transistor MN25 is connected to the control line AZSL, the drain is connected to the source of the transistor MN24, the other end of the capacitor C21, and the anode of the light-emitting element EL, and the source is connected to the power supply line VSS.

With this configuration, in the pixel PIX, when the transistor MN22 is in an on state, the voltage between both ends of the capacitor C21 is set on the basis of the pixel signal supplied from the signal line SGL. The transistor MN23 is turned on and off on the basis of the signal of the control line DSL. The transistor MN24 causes a current corresponding to the voltage between both ends of the capacitor C21 to flow to the light-emitting element EL during the period in which the transistor MN23 is in an on state. The light-emitting element EL emits light on the basis of the current supplied from the transistor MN24. In this manner, the pixel PIX emits light with luminance corresponding to the pixel signal. The transistor MN25 is turned on and off on the basis of the signal of the control line AZSL. During the period in which the transistor MN25 is in an on state, the voltage of the anode of the light-emitting element EL is initialized by being set to the voltage of the power supply line VSS.

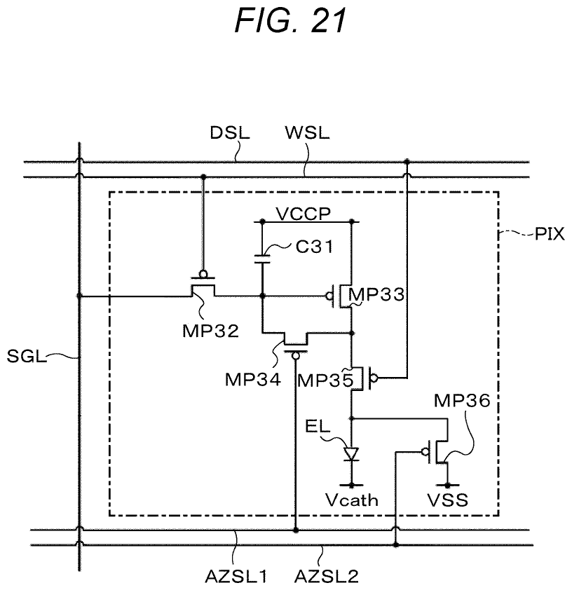

FIG. 21 illustrates another configuration example of the pixel PIX. The pixel PIX includes a capacitor C31, transistors MP32 to MP36, and a light-emitting element EL. The transistors MP32 to MP36 are P-type MOSFETs. The gate of the transistor MP32 is connected to the control line WSL, the source is connected to the signal line SGL, and the drain is connected to the gate of the transistor MP33, the drain of the transistor MP34, and the capacitor C31. One end of the capacitor C31 is connected to the power supply line VCCP, and the other end is connected to the drain of the transistor MP32, the gate of the transistor MP33, and the drain of the transistor MP34. The gate of the transistor MP34 is connected to the control line AZSL1, the source is connected to the drain of the transistor MP33 and the source of the transistor MP35, and the drain is connected to the drain of the transistor MP32, the gate of the transistor MP33, and the other end of the capacitor C31. The gate of the transistor MP35 is connected to the control line DSL, the source is connected to the drain of the transistor MP33 and the source of the transistor MP34, and the drain is connected to the source of the transistor MP36 and the anode of the light-emitting element EL. The gate of the transistor MP36 is connected to the control line AZSL2, the source is connected to the drain of the transistor MP35 and the anode of the light-emitting element EL, and the drain is connected to the power supply line VSS.

With this configuration, in the pixel PIX, the transistor MP32 is in an on state, so that the voltage between both ends of the capacitor C31 is set on the basis of the pixel signal supplied from the signal line SGL. The transistor MP35 is turned on and off on the basis of the signal of the control line DSL. The transistor MP33 causes a current corresponding to the voltage between both ends of the capacitor C31 to flow to the light-emitting element EL during the period in which the transistor MP35 is in an on state. The light-emitting element EL emits light on the basis of the current supplied from the transistor MP33. In this manner, the pixel PIX emits light with luminance corresponding to the pixel signal. The transistor MP34 is turned on and off on the basis of the signal of the control line AZSL1. The drain and the gate of the transistor MP34 are connected to each other during the period in which the transistor MP33 is in an on state. The transistor MP36 is turned on and off on the basis of the signal of the control line AZSL2. During the period in which the transistor MP36 is in an on state, the voltage of the anode of the light-emitting element EL is initialized by being set to the voltage of the power supply line VSS.

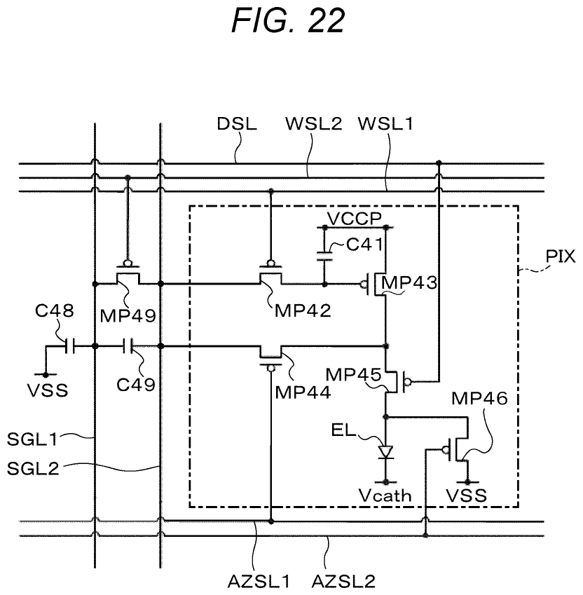

FIG. 22 illustrates another configuration example of the pixel PIX. One end of a capacitor C48 is connected to the signal line SGL1, and the other end is connected to the power supply line VSS. One end of a capacitor C49 is connected to the signal line SGL1, and the other end is connected to the signal line SGL2. A transistor MP49 is a P-type MOSFET, the gate is connected to the control line WSL2, the source is connected to the signal line SGL1, and the drain is connected to the signal line SGL2.

The pixel PIX includes a capacitor C41, transistors MP42 to MP46, and a light-emitting element EL. The transistors MP42 to MP46 are P-type MOSFETs. The gate of the transistor MP42 is connected to the control line WSL1, the source is connected to the signal line SGL2, and the drain is connected to the gate of the transistor MP43 and the capacitor C41. One end of the capacitor 41 is connected to the power supply line VCCP, and the other end is connected to the drain of the transistor MP42 and the gate of the transistor MP43. The gate of the transistor MP43 is connected to the drain of the transistor MP42 and the other end of the capacitor C41, the source is connected to the power supply line VCCP, and the drain is connected to the sources of the transistors MP44 and MP45. The gate of the transistor MP44 is connected to the control line AZSL1, the source is connected to the drain of the transistor MP43 and the source of the transistor MP45, and the drain is connected to the signal line SGL2. The gate of the transistor MP45 is connected to the control line DSL, the source is connected to the drain of the transistor MP43 and the source of the transistor MP44, and the drain is connected to the source of the transistor MP46 and the anode of the light-emitting element EL. The gate of the transistor MP46 is connected to the control line AZSL2, the source is connected to the drain of the transistor MP45 and the anode of the light-emitting element EL, and the drain is connected to the power supply line VSS.

With this configuration, in the pixel PIX, when the transistor MP42 is in an on state, the voltage between both ends of the capacitor C41 is set on the basis of the pixel signal supplied from the signal line SGL1 via the capacitor C49. The transistor MP45 is turned on and off on the basis of the signal of the control line DSL. The transistor MP43 causes a current corresponding to the voltage between both ends of the capacitor C41 to flow through the light-emitting element EL during the period in which the transistor MP45 is in an on state. The light-emitting element EL emits light on the basis of the current supplied from the transistor MP43. In this manner, the pixel PIX emits light with luminance corresponding to the pixel signal. The transistor MP44 is turned on and off on the basis of the signal of the control line AZSL1. During the period in which the transistor MP44 is in an on state, the drain of the transistor MP43 and the signal line SGL2 are connected to each other. The transistor MP46 is turned on and off on the basis of the signal of the control line AZSL2. During the period in which the transistor MP46 is in an on state, the voltage of the anode of the light-emitting element EL is initialized by being set to the voltage of the power supply line VSS.

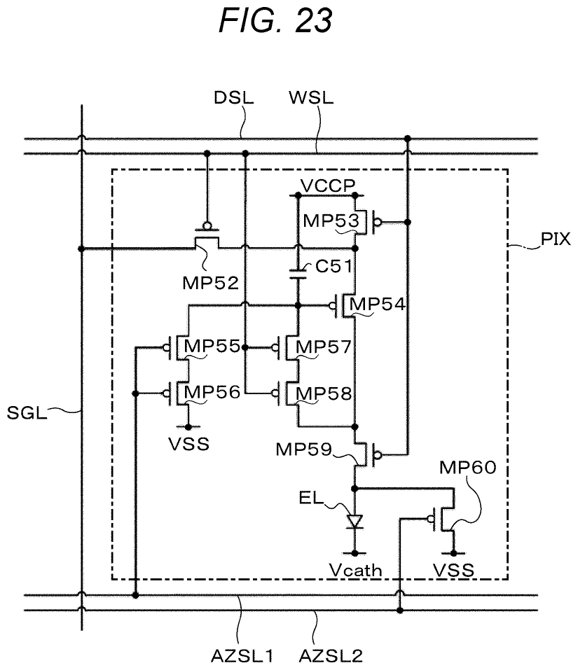

FIG. 23 illustrates another configuration example of the pixel PIX. The pixel PIX includes a capacitor C51, transistors MP52 to MP60, and a light-emitting element EL. The transistors MP52 to MP60 are P-type MOSFETs. The gate of the transistor MP52 is connected to the control line WSL, the source is connected to the signal line SGL, and the drain is connected to the drain of the transistor MP53 and the source of the transistor MP54. The gate of the transistor MP53 is connected to the control line DSL, the source is connected to the power supply line VCCP, and the drain is connected to the drain of the transistor MP52 and the source of the transistor MP54. The gate of the transistor MP54 is connected to the source of the transistor MP55, the drain of the transistor MP57, and the capacitor C51, the source is connected to the drains of the transistors MP52 and MP53, and the drain is connected to the sources of the transistors MP58 and MP59. One end of the capacitor C51 is connected to the power supply line VCCP, and the other end is connected to the gate of the transistor MP54, the source of the transistor MP55, and the drain of the transistor MP57. The capacitor C51 may include two capacitors connected in parallel to each other. The gate of the transistor MP55 is connected to the control line AZSL1, the source is connected to the gate of the transistor MP54, the drain of the transistor MP57, and the other end of the capacitor C51, and the drain is connected to the source of the transistor MP56. The gate of the transistor MP56 is connected to the control line AZSL1, the source is connected to the drain of the transistor MP55, and the drain is connected to the power supply line VSS. The gate of the transistor MP57 is connected to the control line WSL, the drain is connected to the gate of the transistor MP54, the source of the transistor MP55, and the other end of the capacitor C51, and the source is connected to the drain of the transistor MP58. The gate of the transistor MP58 is connected to the control line WSL, the drain is connected to the source of the transistor MP57, and the source is connected to the drain of the transistor MP54 and the source of the transistor MP59. The gate of the transistor 59 is connected to the control line DSL, the source is connected to the drain of the transistor MP54 and the source of the transistor MP58, and the drain is connected to the source of the transistor MP60 and the anode of the light-emitting element EL. The gate of the transistor MP60 is connected to the control line AZSL2, the source is connected to the drain of the transistor MP59 and the anode of the light-emitting element EL, and the drain is connected to the power supply line VSS.

With this configuration, in the pixel PIX, the transistors MP52, MP54, MP58, and MP57 are in an on state, whereby the voltage between both ends of the capacitor C51 is set on the basis of the pixel signal supplied from the signal line SGL. The transistors MP53 and MP59 are turned on and off on the basis of the signal of the control line DSL. The transistor MP54 causes a current corresponding to the voltage between both ends of the capacitor C51 to flow to the light-emitting element EL during the period in which the transistors MP53 and MP59 are in an on state. The light-emitting element EL emits light on the basis of the current supplied from the transistor MP54. In this manner, the pixel PIX emits light with luminance corresponding to the pixel signal. The transistors MP55 and MP56 are turned on and off on the basis of the signal of the control line AZSL1. During the period in which the transistors MP55 and MP56 are in an on state, the voltage of the gate of the transistor MP54 is initialized by being set to the voltage of the power supply line VSS. The transistor MP60 is turned on and off on the basis of the signal of the control line AZSL2. During the period in which the transistor MP60 is in an on state, the voltage of the anode of the light-emitting element EL is initialized by being set to the voltage of the power supply line VSS.

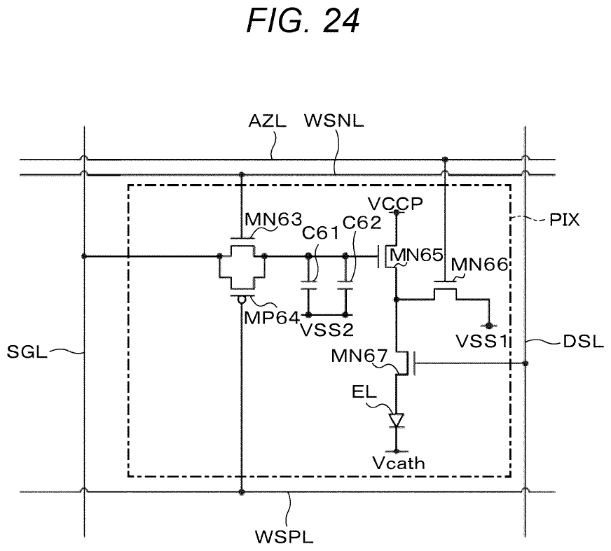

FIG. 24 illustrates another configuration example of the pixel PIX. The signal of the control line WSNL and the signal of the control line WSPL are inverted signals.

The pixel PIX includes capacitors C61 and C62, transistors MN63, MP64, and MN65 to MN67, and a light-emitting element EL. The transistors MN63 and MN65 to MN67 are N-type MOSFETs, and the transistor MP64 is a P-type MOSFET. The gate of the transistor MN63 is connected to the control line WSNL, the drain is connected to the signal line SGL and the source of the transistor MP64, and the source is connected to the drain of the transistor MP64, the capacitors C61 and C62, and the gate of the transistor MN65. The gate of the transistor MP64 is connected to the control line WSPL, the source is connected to the signal line SGL and the drain of the transistor MN63, and the drain is connected to the source of the transistor MN63, the capacitors C61 and C62, and the gate of the transistor MN65. The capacitor C61 includes, for example, a metal oxide metal (MOM) capacitor, one end is connected to the source of the transistor MN63, the drain of the transistor MP64, the capacitor C62, and the gate of the transistor MN65, and the other end is connected to the power supply line VSS2. Note that the capacitor C61 may be configured using, for example, a MOS capacitor or a metal insulator metal (MIM) capacitor. The capacitor C62 includes, for example, a MOS capacitor, one end is connected to the source of the transistor MN63, the drain of the transistor MP64, one end of the capacitor C61, and the gate of the transistor MN65, and the other end is connected to the power supply line VSS2. Note that the capacitor C62 may be configured using, for example, an MOM capacitor or an MIM capacitor. In addition, the other end of the capacitor C62 may be connected to a power supply line VSS3 (not illustrated). The gate of the transistor MN65 is connected to the source of the transistor MN63, the drain of the transistor MP64, and one end of the capacitors C61 and C62, the drain is connected to the power supply line VCCP, and the source is connected to the drains of the transistors MN66 and MN67. The gate of the transistor MN66 is connected to the control line AZL, the drain is connected to the source of the transistor MN65 and the drain of the transistor MN67, and the source is connected to the power supply line VSS1. The gate of the transistor MN67 is connected to the control line DSL, the drain is connected to the source of the transistor MN65 and the drain of the transistor MN66, and the source is connected to the anode of the light-emitting element EL. Note that the transistor MN67 and the control line DSL may not be provided, and the source of the transistor MN65 may be connected to the drain of the transistor MN66 and the anode of the light-emitting element EL.

With this configuration, in the pixel PIX, at least one of the transistors MN63 or MP64 is in an on state, so that the voltage between both ends of the capacitors C61 and C62 is set on the basis of the pixel signal supplied from the signal line SGL. The transistor MN67 is turned on and off on the basis of the signal of the control line DSL. The transistor MN65 causes a current corresponding to the voltage between both ends of the capacitors C61 and C62 to flow to the light-emitting element EL during the period in which the transistor MN67 is in an on state. The light-emitting element EL emits light on the basis of the current supplied from the transistor MP65. In this manner, the pixel PIX emits light with luminance corresponding to the pixel signal. The transistor MN66 may be turned on/off on the basis of the signal of the control line AZL. Furthermore, the transistor MN66 may function as a resistance element having a resistance value corresponding to the signal of the control line AZL. In this case, the transistor MN65 and the transistor MN66 constitute a so-called source follower circuit.

FIG. 25 illustrates another configuration example of the pixel PIX. A plurality of pixels PIX is provided in a matrix in a display area 100, and the display area 100 is provided between a first control unit 40 and a second control unit 70.

The first control unit 40 includes transmission gates TG45 and TG46, transistors MP56 and MP57, and a capacitor C61. The transistors MP56 and MP57 are P-type MOSFETs. A pixel signal is supplied to an input end of the transmission gate TG45, and an output end of the transmission gate TG45 is connected to one end of a signal line 14a. An input end of the transmission gate TG46 is connected to a signal line 14b, and an output end of the transmission gate TG46 is connected to the power supply line Vorst. One end of the capacitor C61 is connected to the signal line 14a, and the other end is connected to the power supply line VSS1. The gate of the transistor MP56 is connected to the control line INIL, the source is connected to the power supply line Vini, and the drain is connected to the signal line 14b. The gate of the transistor MP57 is connected to the control line ELL, the source is connected to the power supply line Vel, and the drain is connected to the signal line 14b.

The second control unit 70 includes a transmission gate TG72, a transistor MP73, and a capacitor C82. The transistor MP73 is a P-type MOSFET. The input end of the transmission gate TG72 is connected to the other end of the signal line 14a, and the output end is connected to the source of the transistor MP73 and one end of the capacitor C82. The gate of the transistor MP73 is connected to the control line REFL, the drain is connected to an output end of the transmission gate TG72 and one end of the capacitor C82, and the source is connected to the power supply line Vref. One end of the capacitor C82 is connected to the output end of the transmission gate TG72 and the drain of the transistor MP73, and the other end is connected to one end of the signal line 14b.

The pixel PIX includes a capacitor C132, transistors MP121 to MP125, and a light-emitting element EL. The transistors MP121 to MP125 are P-type MOSFETs. The gate of the transistor MP122 is connected to the control line WSL, the source is connected to the signal line 14b, and the drain is connected to the gate of the transistor MP121 and the capacitor C132. One end of the capacitor C132 is connected to the power supply line Vel, and the other end is connected to the drain of the transistor MP122 and the gate of the transistor MP121. The gate of the transistor MP121 is connected to the drain of the transistor MP122 and the other end of the capacitor C132, the source is connected to the power supply line Vel, and the drain is connected to the sources of the transistors MP123 and MP124. The gate of the transistor MP123 is connected to the control line AZSL, the source is connected to the drain of the transistor MP121 and the source of the transistor MP124, and the drain is connected to the signal line 14b. The gate of the transistor MP124 is connected to the control line DSL, the source is connected to the drain of the transistor MP121 and the source of the transistor MP123, and the drain is connected to the drain of the transistor MP125 and the anode of the light-emitting element 130. The gate of the transistor MP125 is connected to the control line AZSL, the source is connected to the power supply line Vorst, and the drain is connected to the drain of the transistor MP124 and the anode of the light-emitting element 130.

With this configuration, in the pixel PIX, when the transistor MP122 is in an on state, the voltage between both ends of the capacitor C132 is set on the basis of the pixel signal supplied via the transmission gate TG45, the signal line 14a, the transmission gate TG72, the capacitor C82, and the signal line 14b. The transistor MP124 is turned on and off on the basis of the signal of the control line DSL. The transistor MP121 causes a current corresponding to the voltage between both ends of the capacitor C132 to flow through the light-emitting element EL during the period in which the transistor MP124 is in an on state. The light-emitting element EL emits light on the basis of the current supplied from the transistor MP121. In this manner, the pixel PIX emits light with luminance corresponding to the pixel signal. The transistors MP123 and MP125 are turned on and off on the basis of the signal of the control line AZSL. During a period in which the transistor MP123 is in an on state, the drain of the transistor MP121 and the source of the transistor MP124 are connected to the signal line 14b. During the period in which the transistor MP125 is in an on state, the voltage of the anode of the light-emitting element EL is initialized by being set to the voltage of the power supply line Vorst. Further, the transistor MP56 is turned on/off on the basis of the signal of the control line INIL, the transistor MP57 is turned on/off on the basis of the signal of the control line ELL, and the transistor MP73 is turned on/off on the basis of the signal of the control line REFL. When the transistor MP56 is in an on state, the signal line 14b is set to the voltage of the power supply line Vini, and when the transistor MP57 is in an on state, the signal line 14b is set to the voltage of the power supply line Vel. When the transistor MP73 is in an on state, one end of the capacitor C82 is initialized by being set to the voltage of the power supply line Vref.

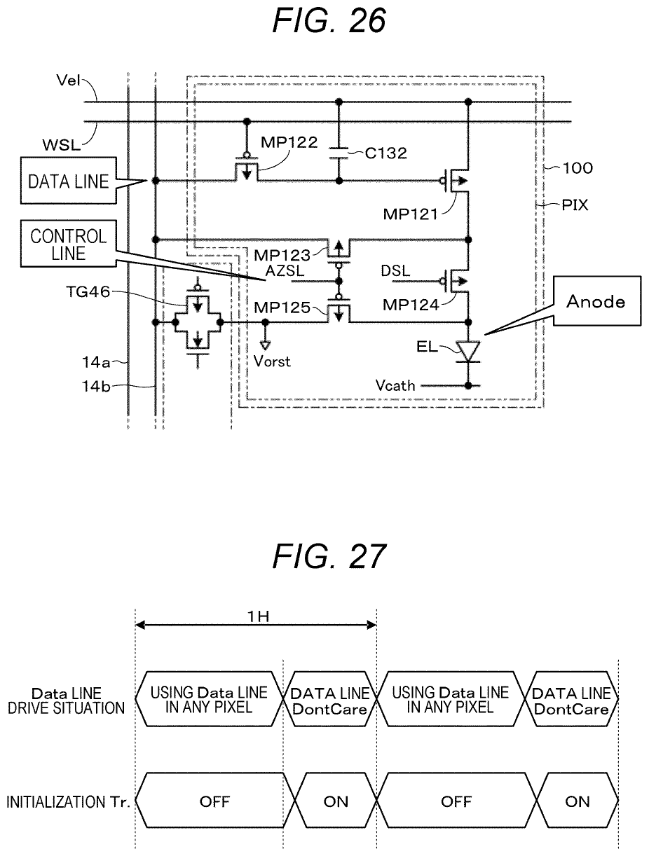

Here, a specific example (Specific example 3) of the operation of the display device 1 described above will be described in detail using the pixel PIX illustrated in FIG. 25 as an example. Each pixel PIX may be extinguished at a predetermined timing or may be written. FIG. 26 is a diagram for explaining an influence on driving of another pixel PIX. Note that the illustrated pixel PIX illustrates a state in which the potential of the anode of another pixel PIX at a distant position is initialized. In the pixel PIX, the initialization transistor is turned on and off by a signal of a control line AZSL common to another transistor. In addition, the drive transistor that is turned on at the time of light emission extends over the two nodes.

Therefore, as illustrated in the drawing, when the transistors MP123 and MP125 controlled by the control line AZSL are turned on and the transistor MP124 is turned on, it is considered that a short circuit occurs between the node to which the pixel signal enters and the anode of the light-emitting element EL to which the voltage Vorst is supplied via the transistor MP125, and the pixel signal voltage changes. That is, when the initialization transistor is turned on, the initialization potential is conducted with the data writing wiring (data line) vertically connected, and there is a possibility that the data writing of the other pixels PIX in the array is adversely affected depending on the timing within 1H (horizontal period).

Therefore, as illustrated in FIG. 27, in order not to affect the driving of other pixels PIX, it is preferable to perform the initialization at a specific timing not to affect the driving of other pixels PIX in 1H even during the period in which the initialization transistor is turned on. That is, the initialization transistor is turned off in the period in which the data line is used in any pixel PIX, and the initialization transistor is turned on in the period in which the data line is not used. Consequently, the initialization can more appropriately be performed without affecting the driving of each pixel PIX. Note that the present example is merely an example, and the present invention is not limited to the data line, and initialization is only required to be performed at a timing that does not affect driving of the own pixel or another pixel.

### 4. Application Example

### (Electronic Apparatus)

The display devices 1 and 1A according to the embodiment described above may be provided in various electronic apparatuses. Application examples of the electronic apparatus include, for example, the following.

### Application Example 1

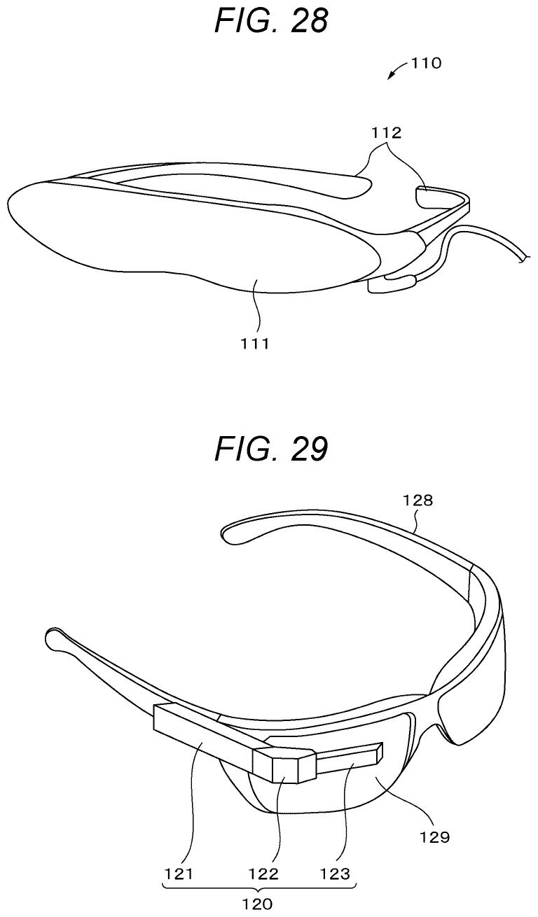

FIG. 28 illustrates an example of an external appearance of a head-mounted display 110. The head-mounted display 110 includes, for example, ear hooking portions 112 for a user to wear the head-mounted display 110 on the head, on both sides of a display unit 111 having a shape of eyeglasses. The display unit 111 includes the display device 1 or the display device 1A described above.

### Application Example 2

FIG. 29 illustrates an example of an appearance of a see-through head mounted display 120. The see-through head mounted display 120 includes a main body 121, an arm 122, and a lens barrel 123.

The main body 121 is connected to an arm 122 and glasses 128. Specifically, an end portion of the main body 121 in the long side direction is coupled to the arm 122, and one side of the side surface of the main body 121 is coupled to the glasses 128 via a connecting member. Note that the main body 121 may be directly mounted on the head of the human body.

The main body 121 incorporates a control board for controlling the operation of the see-through head mounted display 120 and a display unit. The arm 122 connects the main body 121 and the lens barrel 123 and supports the lens barrel 123. Specifically, the arm 122 is coupled to the end of the main body 121 and the end of the lens barrel 123, and fixes the lens barrel 123. Furthermore, the arm 122 incorporates a signal line for communicating data related to an image provided from the main body 121 to the lens barrel 123.

The lens barrel 123 projects image light provided from the main body 121 via the arm 122 toward the eyes of the user wearing the see-through head mounted display 120 through an eyepiece 129. In the see-through head mounted display 120, the display unit of the main body 121 includes the display device 1 or the display device 1A described above.

### Application Example 3

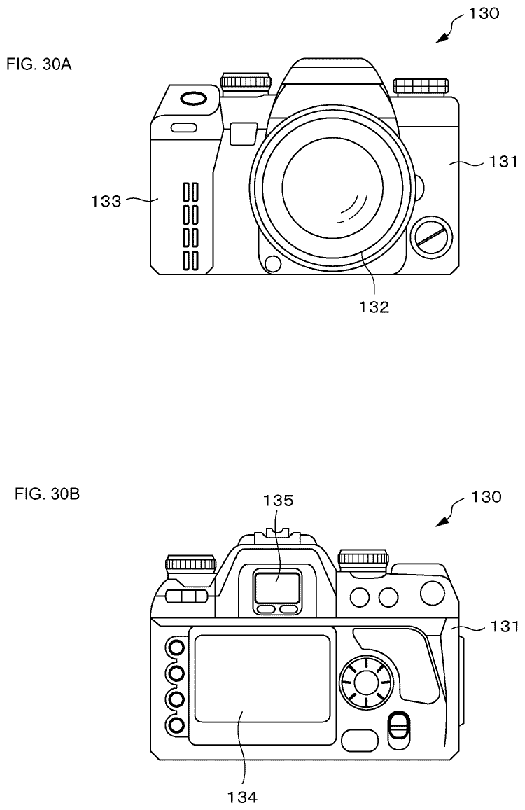

FIGS. 30A and 30B illustrate an example of an external appearance of a digital still camera 130. The digital still camera 130 is of a lens interchangeable single-lens reflex type, and includes an interchangeable imaging lens unit (interchangeable lens) 132 substantially at the center on the front surface of a camera main body (camera body) 131, and a grip part 133 to be held by a photographer on the front left side.

A monitor 134 is provided at a position shifted to the left from the center of the back surface of the camera body 131. An electronic view finder (eyepiece window) 135 is provided above the monitor 134. By looking into the electronic view finder 135, the photographer can determine the composition by visually recognizing the optical image of the subject guided from the imaging lens unit 132. The electronic view finder 135 includes the display device 1 or the display device 1A described above.

### Application Example 4

FIG. 31 illustrates an example of an external appearance of a television device 140. The television device 140 includes, for example, a video display screen unit 141 including a front panel 142 and a filter glass 143, and the video display screen unit 141 includes the display device 1 or the display device 1A described above.

### Application Example 5

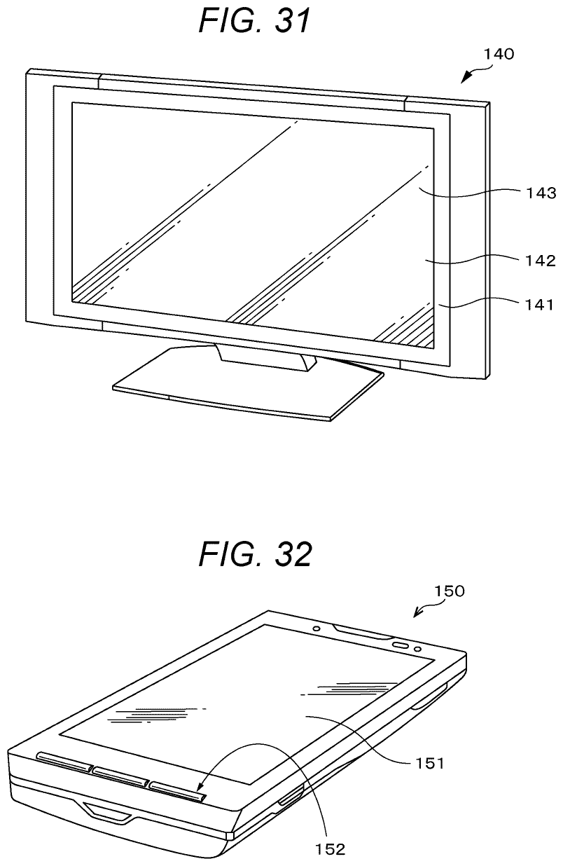

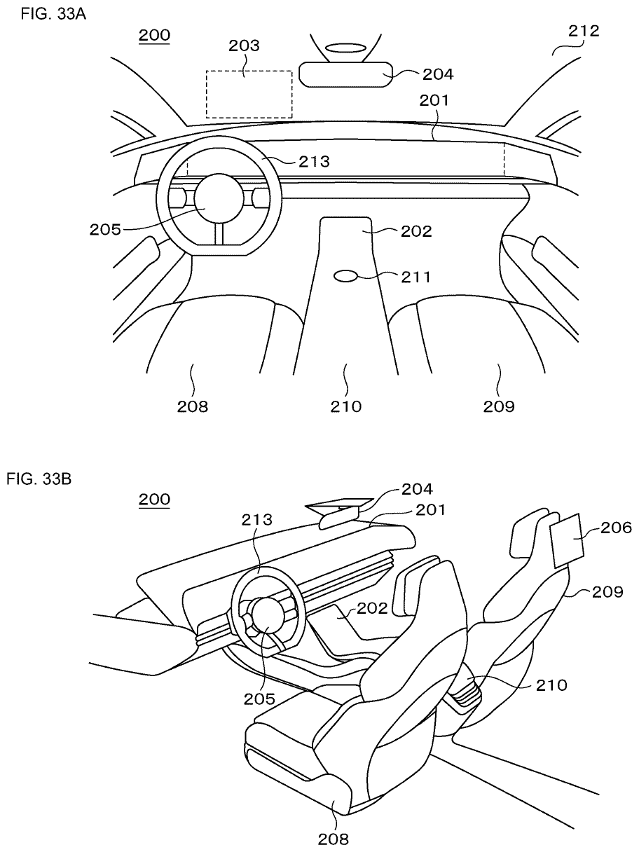

FIG. 32 illustrates an example of an external appearance of a smartphone 150. The smartphone 150 includes a display unit 151 for displaying various types of information, an operation unit 152 including a button for receiving an operation input by the user, and the like. The display unit 151 includes the display device 1 or the display device 1A described above.

### Application Example 6

The display devices 1 and 1A described above may be provided in various displays provided in the vehicle.

FIGS. 33A and 33B are diagrams illustrating an example of an internal configuration of a vehicle 200 provided with various displays. Specifically, FIG. 33A is a diagram illustrating an example of an internal state of the vehicle 200 from the rear to the front of the vehicle 200, and FIG. 33B is a diagram illustrating an example of an internal state of the vehicle 200 from the oblique rear to the oblique front of the vehicle 200.

The vehicle 200 includes a center display 201, a console display 202, a head-up display 203, a digital rear mirror 204, a steering wheel display 205, and a rear entertainment display 206. At least one of these displays includes the display device 1 or the display device 1A described above. For example, all of these displays may include at least one of the display device 1 and the display device 1A described above.

The center display 201 is disposed on a dashboard portion facing a driver's seat 208 and a passenger seat 209. FIGS. 33A and 33B illustrate an example of the center display 201 having a horizontally long shape extending from the driver's seat 208 side to the passenger seat 209 side, but the screen size and the arrangement place of the center display 201 are arbitrary. The center display 201 can display information detected by various sensors. As a specific example, the center display 201 can display a captured image captured by the image sensor, a distance image to an obstacle in front of or on a side of the vehicle 200 measured by the ToF sensor, a passenger's body temperature detected by the infrared sensor, and the like. The center display 201 can be used to display, for example, at least one of safety-related information, operation-related information, a life log, health-related information, authentication/identification-related information, or entertainment-related information.

The safety-related information is information such as doze detection, looking-away detection, detection of mischief of a child riding together, presence or absence of wearing of a seat belt, and detection of leaving of an occupant, and is information detected by a sensor disposed, for example, to overlap with the back surface side of the center display 201. The operation-related information detects gestures related to operations by the occupant by using the sensor. Gestures to be detected may include operations of various types of equipment in the vehicle 200. For example, operations of air conditioning equipment, a navigation device, an audiovisual (AV) device, a lighting device, and the like are detected. The life log includes life logs of all the occupants. For example, the lifelogs include an action record of each occupant in the vehicle. By acquiring and storing the life log, a condition of the occupant can be confirmed at a time of an accident. The health-related information detects the body temperature of the occupant, by using a sensor such as a temperature sensor, and estimates the health condition of the occupant on the basis of the detected body temperature. Alternatively, the face of the occupant may be captured by using an image sensor, and the health condition of the occupant may be estimated from the captured facial expression. Moreover, a conversation may be made with the occupant in automatic voice, and the health condition of the occupant may be estimated on the basis of the contents of a response from the occupant. The authentication/identification-related information includes information on a keyless entry function of performing face authentication by using a sensor, and a function of automatically adjusting a seat height and position through face identification. The entertainment-related information includes information on a function of detecting, with a sensor, operation information about an AV device being used by the occupant, and a function of recognizing the face of the occupant with the sensor and providing content suitable for the occupant through the AV device.

The console display 202 can be used to display the life log information, for example. The console display 202 is disposed near a shift lever 211 of a center console 210 between the driver's seat 208 and the passenger seat 209. The console display 202 can also display information detected by various sensors. In addition, the console display 202 may display an image of the periphery of the vehicle captured by the image sensor, or may display a distance image to an obstacle in the periphery of the vehicle.

The head-up display 203 is virtually displayed behind a windshield 212 in front of the driver's seat 208. The head-up display 203 can be used to display, for example, at least one of the safety-related information, the operation-related information, the life log, the health-related information, the authentication/identification-related information, or the entertainment-related information. Since the head-up display 203 is virtually arranged in front of the driver's seat 208 in many cases, it is suitable for displaying information directly related to the operation of the vehicle 200 such as the speed of the vehicle 200 and the remaining amount of fuel (battery).

The digital rear mirror 204 can not only display the rear of the vehicle 200 but also display the state of the occupant in the rear seat, and thus can be used to display the life log information, for example, by disposing the sensor to be superimposed on the back surface side of the digital rear mirror 204.

The steering wheel display 205 is disposed near the center of a steering wheel 213 of the vehicle 200. The steering wheel display 205 can be used to display, for example, at least one of the safety-related information, the operation-related information, the life log, the health-related information, the authentication/identification-related information, or the entertainment-related information. In particular, since the steering wheel display 205 is close to the driver's hand, it is suitable for displaying life log information such as the body temperature of the driver, or for displaying information regarding the operation of an AV device, an air conditioning facility, or the like.

The rear entertainment display 206 is attached to the back side of the driver's seat 208 and the passenger seat 209, and is for viewing by an occupant in the rear seat. The rear entertainment display 206 can be used to display, for example, at least one of the safety-related information, the operation-related information, the life log, the health-related information, the authentication/identification-related information, or the entertainment-related information. In particular, because the rear entertainment display 206 is in front of the occupant in the rear seat, information regarding the occupant in the rear seat is displayed. For example, information regarding the operation of the AV device or the air conditioning equipment may be displayed, or a result of measuring the body temperature or the like of the occupant in the rear seat by the temperature sensor may be displayed.

A sensor may be disposed on the back surface side of each of the display devices 1 and 1A to measure a distance to an object existing in the surroundings. Optical distance measurement methods are roughly classified into a passive type and an active type. By the method of the passive type, distance measurement is performed by receiving light from an object, without projecting light from a sensor to the object. The method of the passive type includes a lens focus method, a stereo method, a monocular vision method, and the like. By the method of the active type, distance measurement is performed by projecting light onto an object, and receiving reflected light from the object with a sensor to measure the distance. The method of the active type includes an optical radar method, an active stereo method, an illuminance difference stereo method, a moire topography method, and an interference method. The display devices 1 and 1A described above can be applied to any of these types of distance measurement. The passive or active distance measurement described above can be performed by using a sensor disposed to overlap the back surface side of the display devices 1 and 1A.

### 5. Modification

Although the embodiments of the present technology are heretofore described specifically, the contents of the present technology are not limited to the above-described embodiments, and various modifications based on the technical idea of the present technology may be made. For example, the configurations, methods, steps, shapes, materials, numerical values, and the like of the embodiments described above can be combined or exchanged with each other without departing from the gist of the present technology. Furthermore, one may be divided into two or more, and a part thereof may be omitted. For example, the pixel PIX is not limited to the configuration described above, and can be changed as appropriate, for example, by changing a P-channel transistor to an N-channel transistor. The type, number, and connection of the transistor, the capacitor, and the light-emitting element can be appropriately changed. Various pixel signals and control signals are only required to be generated in accordance therewith and supplied to the pixel PIX.

Note that the present technology can also adopt the following configurations.

(1)

A display device including:
a pixel circuit including a light-emitting element, a first transistor that causes a current based on a pixel signal to flow through the light-emitting element, and a second transistor that sets a potential of an anode of the light-emitting element to an initialization potential in an on-state, in which the second transistor is turned on one or more times during a light emission period of the light-emitting element.
   (2)

The display device according to (1), in which
a period and a number of times during which the second transistor is turned on are set such that a potential of the anode does not exceed a light emission threshold potential of the light-emitting element during a light emission period when a pixel outputs a lowest gradation.
   (3)

The display device according to (1) or (2), in which
the second transistor operates at an on-off rate different from an on-off rate in a period other than the light emission period during the light emission period.
   (4)

The display device according to any one of (1) to (3), in which
the second transistor is turned on a number of times corresponding to an amount of leakage current to the anode during an on period in the light emission period and a light emission period when a pixel outputs a lowest gradation.
   (5)

The display device according to any one of (1) to (4), in which
the display device supports a plurality of different frame rates, and
makes an on/off period of the second transistor during the light emission period at a low frame rate the same as a time length of an on/off period of the second transistor during the light emission period at a high frame rate.
   (6)

The display device according to any one of (1) to (5), in which
an on/off period of the second transistor during the light emission period is optimized according to a temperature of the pixel circuit detected by a temperature sensor.
   (7)

The display device according to any one of (1) to (6), in which
the pixel circuit includes a third transistor,
the first transistor is turned on during a period in which the third transistor is in an on state, and
an off period of the third transistor is included in at least a part of a period in which the second transistor is turned on.
   (8)

The display device according to any one of (1) to (7), in which
the second transistor is turned on at timing that does not affect operation of each pixel circuit including a self-pixel circuit.
   (9)

The display device according to any one of (1) to (8), in which
the second transistor is turned on for a period during which a decrease in light emission current during light emission of the light-emitting element falls within a predetermined amount.
   (10)

The display device according to any one of (1) to (9), in which
the pixel circuit includes a capacitor and a fourth transistor that sets a voltage between both ends of the capacitor on the basis of the pixel signal, and
the first transistor causes a current corresponding to the voltage between both ends of the capacitor to flow through the light-emitting element.
   (11)

The display device according to any one of (1) to (10), in which
a gate of the second transistor is connected to a control line, one of a source and a drain is connected between one of a source and a drain of the first transistor and the anode of the light-emitting element, and the other of the source and the drain is connected to a power supply line.
   (12)
an electronic apparatus including the display device according to any one of (1) to (11).

### REFERENCE SIGNS LIST

1, 1A Display device
2 Pixel portion
3 Horizontal selector
4 Vertical scanner
5 Write scanner
6 Drive scanner
7 Auto zero scanner
8 Temperature detection circuit
9 Timing controller
PIX Pixel (pixel circuit)
SGL Signal line
WSL, DSL, AZSL Control line
MP12˜MP15 Transistor
C11, C12 Capacitor
EL Light-emitting element

1. A display device comprising:
a pixel circuit including a light-emitting element, a first transistor that causes a current based on a pixel signal to flow through the light-emitting element, and a second transistor that sets a potential of an anode of the light-emitting element to an initialization potential in an on-state, wherein
the second transistor is turned on one or more times during a light emission period of the light-emitting element.

2. The display device according to claim 1, wherein
a period and a number of times during which the second transistor is turned on are set such that a potential of the anode does not exceed a light emission threshold potential of the light-emitting element during a light emission period when a pixel outputs a lowest gradation.

3. The display device according to claim 1, wherein
the second transistor operates at an on-off rate different from an on-off rate in a period other than the light emission period during the light emission period.

4. The display device according to claim 1, wherein
the second transistor is turned on a number of times corresponding to an amount of leakage current to the anode during an on period in the light emission period and a light emission period when a pixel outputs a lowest gradation.

5. The display device according to claim 1, wherein
the display device supports a plurality of different frame rates, and
makes an on/off period of the second transistor during the light emission period at a low frame rate the same as a time length of an on/off period of the second transistor during the light emission period at a high frame rate.

6. The display device according to claim 1, wherein
an on/off period of the second transistor during the light emission period is optimized according to a temperature of the pixel circuit detected by a temperature sensor.

7. The display device according to claim 1, wherein
the pixel circuit includes a third transistor,
the first transistor is turned on during a period in which the third transistor is in an on state, and
an off period of the third transistor is included in at least a part of a period in which the second transistor is turned on.

8. The display device according to claim 1, wherein
the second transistor is turned on at timing that does not affect operation of each pixel circuit including a self-pixel circuit.

9. The display device according to claim 1, wherein
the second transistor is turned on for a period during which a decrease in light emission current during light emission of the light-emitting element falls within a predetermined amount.

10. The display device according to claim 1, wherein
the pixel circuit includes a capacitor and a fourth transistor that sets a voltage between both ends of the capacitor on a basis of the pixel signal, and
the first transistor causes a current corresponding to the voltage between both ends of the capacitor to flow through the light-emitting element.

11. The display device according to claim 1, wherein
a gate of the second transistor is connected to a control line, one of a source and a drain is connected between one of a source and a drain of the first transistor and the anode of the light-emitting element, and the other of the source and the drain is connected to a power supply line.

12. An electronic apparatus comprising the display device according to claim 1.
